(19) United States
(12) Patent Application Publication
(10) Pub. No.: US 2016/0378029 A1
(43) Pub. Date: Dec. 29, 2016

(54) HEATING UNIT, FIXING DEVICE, AND IMAGE FORMING APPARATUS

(71) Applicant: FUJI XEROX CO., LTD., Tokyo (JP)

(72) Inventors: Kazuyoshi ITOH, Kanagawa (JP); Masahiko FUJITA, Kanagawa (JP); Atsumi KURITA, Kanagawa (JP)

(21) Appl. No.: 14/925,302

(22) Filed: Oct. 28, 2015

(30) Foreign Application Priority Data
Jun. 29, 2015 (JP) 2015-130154

(51) Int. Cl. G03G 15/20

(52) U.S. Cl. CPC G03G 15/2053; H05B 6/06

(57) ABSTRACT

A heating unit includes the following elements. A magnetic-field generating member generates a magnetic field. An endless belt-shaped member has an inner peripheral surface to which a lubricant is applied and an outer peripheral surface, a portion of the outer peripheral surface opposing the magnetic-field generating member. The endless belt-shaped member rotates in a peripheral direction and generates heat by electromagnetic induction of the magnetic field. A temperature-sensitive magnetic plate is in contact with a portion of the inner peripheral surface of the endless belt-shaped member which opposes the magnetic-field generating member. A substrate is disposed on a side of the temperature-sensitive magnetic plate which does not face the endless belt-shaped member. An upstream end of the substrate is positioned on a farther downstream side than an upstream end of the temperature-sensitive magnetic plate in a rotating direction of the endless belt-shaped member.

### CROSS-REFERENCE TO RELATED APPLICATIONS

This application is based on and claims priority under 35 USC 119 from Japanese Patent Application No. 2015-130154 filed Jun. 29, 2015.

### BACKGROUND

### Technical Field

The present invention relates to a heating unit, a fixing device, and an image forming apparatus.

### SUMMARY

According to an aspect of the invention, there is provided a heating unit including the following elements. A magnetic-field generating member generates a magnetic field. An endless belt-shaped member is formed in an endless belt shape and has an inner peripheral surface to which a lubricant is applied and an outer peripheral surface, a portion of the outer peripheral surface opposing the magnetic-field generating member. The endless belt-shaped member rotates in a peripheral direction and generates heat by electromagnetic induction of the magnetic field. A temperature-sensitive magnetic plate is in contact with a portion of the inner peripheral surface of the endless belt-shaped member which opposes the magnetic-field generating member. A substrate is disposed on a side of the temperature-sensitive magnetic plate which does not face the endless belt-shaped member. An upstream end of the substrate is positioned on a farther downstream side than an upstream end of the temperature-sensitive magnetic plate in a rotating direction of the endless belt-shaped member.

### BRIEF DESCRIPTION OF THE DRAWINGS

An exemplary embodiment of the present invention will be described in detail based on the following figures, wherein:

FIG. 1 is a sectional view illustrating a heating unit according to an exemplary embodiment of the invention;

FIGS. 2 and 3 are sectional views illustrating a fixing device according to an exemplary embodiment of the invention;

FIGS. 4A through 5C are enlarged sectional views illustrating a heating unit according to an exemplary embodiment of the invention;

FIG. 6 is a graph schematically illustrating the relationship between the temperature and the permeability of a temperature-sensitive magnetic member used in a heating unit according to an exemplary embodiment of the invention;

FIG. 7 is a sectional view illustrating a fixing belt used in a fixing unit according to an exemplary embodiment of the invention;

FIG. 8 is a schematic view illustrating image forming units used in an image forming apparatus according to an exemplary embodiment of the invention;

FIG. 9 is a schematic view illustrating an image forming apparatus according to an exemplary embodiment of the invention;

FIG. 10 is a sectional view illustrating a heating unit according to a comparative example; and

FIGS. 11A through 12B are enlarged sectional views illustrating a heating unit according to a comparative example.

### DETAILED DESCRIPTION

Examples of a heating unit 82, a fixing device 80, and an image forming apparatus 10 according to an exemplary embodiment of the invention will be described below with reference to the accompanying drawings. In the drawings, the arrow H indicates the top-bottom direction (vertical direction) of the heating unit 82, the fixing device 80, and the image forming apparatus 10, and the arrow W indicates the widthwise direction (horizontal direction) of the heating unit 82, the fixing device 80, and the image forming apparatus 10.

### (Overall Configuration)

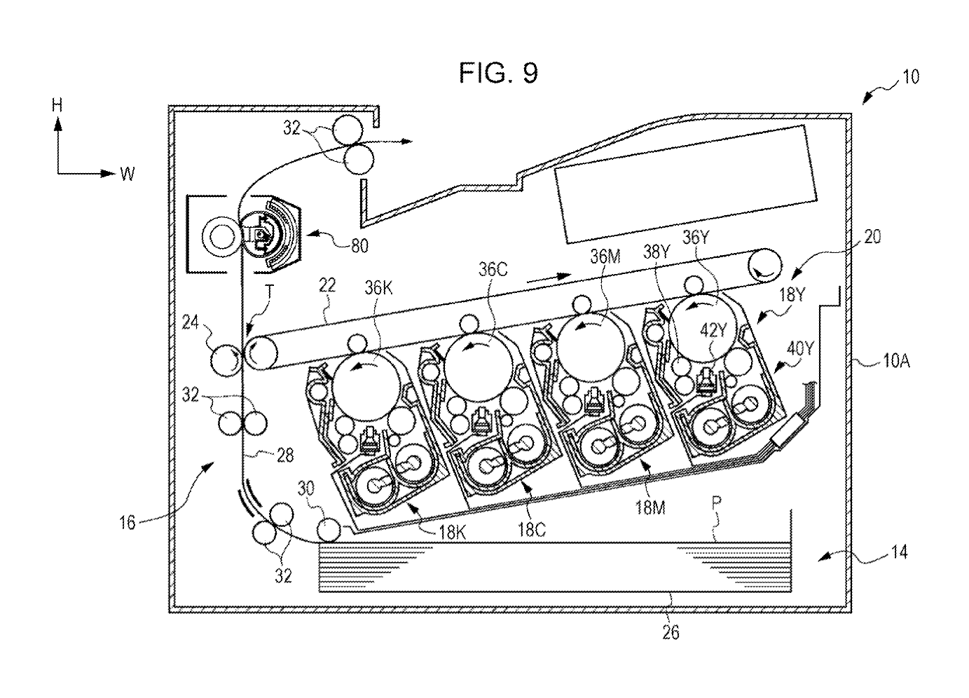

As shown in FIG. 9, the image forming apparatus 10 according to this exemplary embodiment includes a storage unit 14, a transport unit 16, and an image forming device 20 in this order from the bottom side to the top side of the top-bottom direction (direction indicated by the arrow H). In the storage unit 14, sheet members P, which serve as recording mediums, are stored. The transport unit 16 transports sheet members P stored in the storage unit 14. The image forming device 20 forms an image on a sheet member P transported from the storage unit 14 by the transport unit 16.

### [Storage Unit]

The storage unit 14 includes a storage member 26 which can be pulled out of a body 10A of the image forming apparatus 10 toward the near side (toward a user) of the depth direction. Within this storage member 26, sheet members P are stored. The storage unit 14 also includes a feeder roller 30 which feeds sheet members P stored in the storage member 26 to a transport path 28 which forms the transport unit 16.

### [Transport Unit]

The transport unit 16 includes plural transport rollers 32 which transport a sheet member P along the transport path 28.

### [Image Forming Device]

The image forming device 20 includes four yellow (Y), magenta (M), cyan (C), and black (K) image forming units 18Y, 18M, 18C, and 18K. Hereinafter, the image forming units 18Y, 18M, 18C, and 18K may be simply referred to as an “image forming unit 18” or “image forming units 18” unless it is necessary to distinguish the colors Y, M, C, and K from each other.

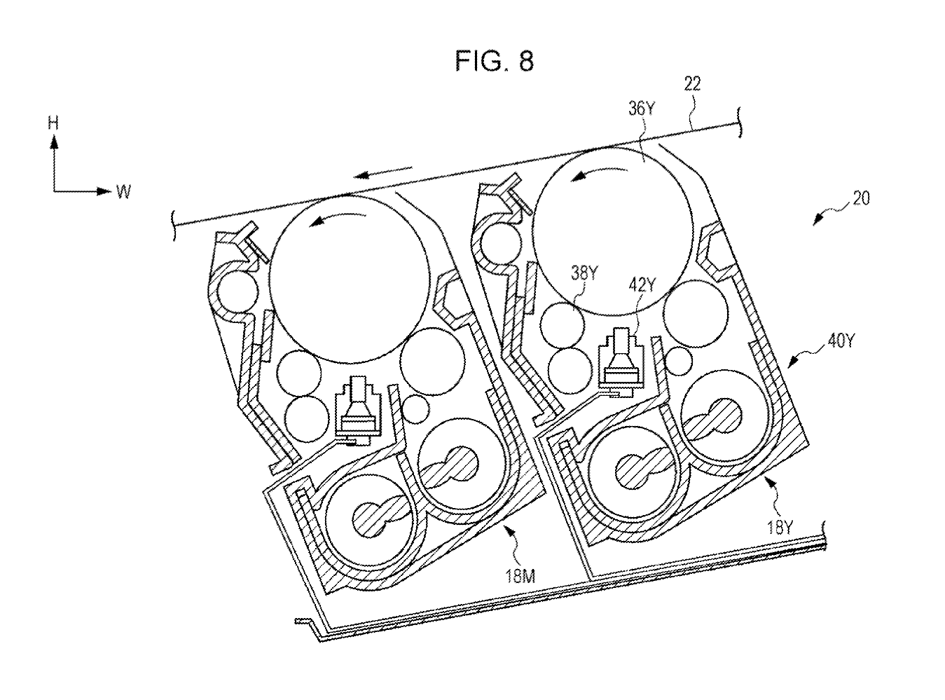

As shown in FIG. 8, each image forming unit 18 includes an image carrier 36, a charging roller 38, an exposure device 42, and a developing device 40. The charging roller 38 charges the surface of the image carrier 36. The exposure device 42 irradiates the charged image carrier 36 with exposure light of a corresponding color so as to form an electrostatic latent image on the charged image carrier 36. The developing device 40 develops an electrostatic latent image formed on the charged image carrier 36 so as to visualize it as a toner image.

As shown in FIG. 9, the image forming device 20 includes an endless transfer belt 22 and a transfer roller 24. Toner images formed by the individual image forming units 18 are transferred to the endless transfer belt 22. The transfer roller 24 transfers the toner images on the transfer belt 22 to a sheet member P.

The image forming device 20 also includes a fixing device 80 which heats and pressurizes toner images on a sheet member P so as to fix the toner images on the sheet member P.

Details of the fixing device 80 will be discussed later.

### (Operation of Image Forming Apparatus)

In the image forming apparatus 10, an image is formed in the following manner.

In each image forming unit 18, the charging roller 38 to which a voltage is applied is in contact with the surface of the image carrier 36 so as to negatively charge the surface of the image carrier 36 at a predetermined potential uniformly. Then, on the basis of image data input from an external source, the exposure device 42 irradiates the surface of the charged image carrier 36 with exposure light so as to form an electrostatic latent image thereon.

In this manner, in the plural image forming units 18, electrostatic latent images based on the image data are formed on the surfaces of the image carriers 36. Then, the developing devices 40 develop these electrostatic latent images so as to visualize them as toner images. The toner images formed on the surfaces of the image carriers 36 are transferred to the transfer belt 22.

Then, a sheet member P which is fed to the transport path 28 from the storage member 26 by the feeder roller 30 is fed to a transfer position T at which the transfer belt 22 and the transfer roller 24 are in contact with each other. The sheet member P is transported to the transport position T and is clamped between the transfer belt 22 and the transfer roller 24, so that the toner images on the surface of the transfer belt 22 are transferred to the sheet member P at the transfer position T.

The toner images transferred to the sheet member P are fixed on the sheet member P by the fixing device 80. Then, the sheet member P having the toner images fixed thereon is discharged to the outside of the body 10A by the transport rollers 32.

### (Configuration of Fixing Device)

The fixing device 80 will be discussed below.

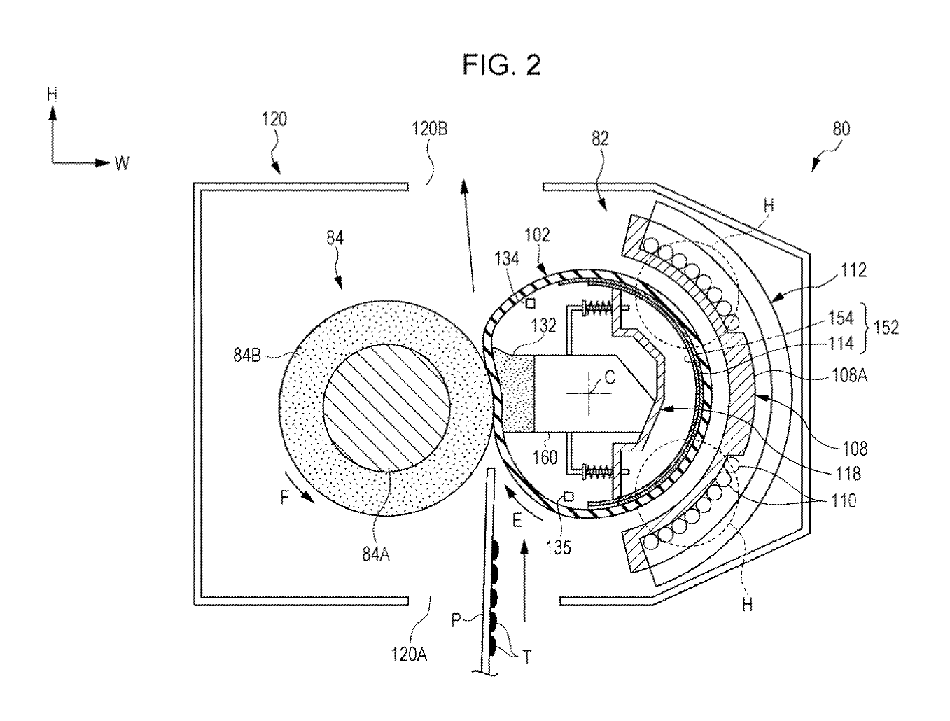

As shown in FIG. 2, the fixing device 80 includes a housing 120 having openings 120A and 120B through which a sheet member P enters and exits. Within the housing 120, a heating unit 82 and a pressurizing roller 84 are disposed. The heating unit 82 heats toner images transferred to a sheet member P. The pressurizing roller 84, which is an example of a pressurizing member, pressurizes a sheet member P in a direction toward the heating unit 82.

### [Heating Unit]

The heating unit 82 includes an endless (tubular) fixing belt 102, which is an example of an endless belt-shaped member. Cap members (not shown) formed in a cylindrical shape and having a rotational axis are fit into and fixed at both sides of the fixing belt 102, so that the fixing belt 102 is supported rotatably about the rotational axis C. A gear is formed in one cap member so that it can transfer the torque of a motor (not shown) for rotating the fixing belt 102. Then, by driving the motor, the fixing belt 102 is rotated in the direction indicated by the arrow E (clockwise direction).

A bobbin 108 made of an insulating member is located at a position at which it opposes part of the outer peripheral surface of the fixing belt 102.

### [Bobbin]

The bobbin 108 is formed in an arc-like shape which follows the outer peripheral surface of the fixing belt 102, as viewed from the direction of the rotational axis of the fixing belt 102 (the same direction as the depth direction of the fixing device 80). In the bobbin 108, a projecting portion 108A is formed at the center of the peripheral surface which does not face the fixing belt 102.

An excitation coil 110, which is an example of a magnetic-field generating member for generating a magnetic field H by means of an electric current, is wound on the bobbin 108 around the projecting portion 108A by multiple turns. A magnetic core 112 formed in an arc-like shape which follows the arc-like shape of the bobbin 108 is located at a position at which the magnetic core 112 opposes the excitation coil 110. The magnetic core 112 is supported by the bobbin 108.

### [Fixing Belt]

As shown in FIG. 7, the fixing belt 102 is constituted by a base layer 124, a heat generating layer 126, an elastic layer 128, and a releasing layer 130 in this order from the inner side to the outer side. The fixing belt 102 is integrally formed by stacking these layers on each other. The diameter of the fixing belt 102 is, for example, 30 mm, and the length thereof in the depth direction is, for example, 370 mm.

The base layer 124 is constituted by a member having a sufficient strength to support the heat generating layer 126 and being resistant to heat. This member also allows the magnetic flux of the magnetic field H to penetrate through the base layer 124 and is unlikely to generate heat by the action of the magnetic field H. In this exemplary embodiment, as the base layer 124, nonmagnetic stainless steel having a thickness of 35 μm is used.

The heat generating layer 126 is constituted by a member which generates heat by electromagnetic induction. The heat generating layer 126 is formed thinner than the skin depth through which the magnetic field H may penetrate so as to allow the magnetic flux of the magnetic field H to penetrate through the heat generating layer 126. In this exemplary embodiment, as the heat generating layer 126, copper having a thickness of 10 μm is used.

The elastic layer 128 is constituted by a member having elasticity and heat resistance. In this exemplary embodiment, as the elastic layer 128, silicone rubber having a thickness of 200 μm is used.

The releasing layer 130 is constituted by a member which facilitates the separation of a sheet member P from the fixing belt 102. In this exemplary embodiment, as the releasing layer 130, tetrafluoroethylene-perfluoroalkoxyethylene copolymer resin having a thickness of 30 μm is used.

In order to reduce the frictional resistance with a temperature-sensitive magnetic plate 114, which will be discussed later, a lubricant (for example, silicone oil) is applied to the inner peripheral surface of the fixing belt 102. The lubricant is a type of oil used as a lubricating agent for efficiently lubricating, for example, a machine gear.

As shown in FIG. 2, a temperature detection sensor 134 for detecting the temperature of the fixing belt 102 is disposed farther inward than the fixing belt 102 and in a region where the temperature detection sensor 134 does not oppose the excitation coil 110 in the radial direction and close to a region where a sheet member P is discharged (exits) (region on the upper side of FIG. 2).

A contact member 152 is also disposed farther inward than the fixing belt 102 and in a region where the contact member 152 opposes the bobbin 108 in the radial direction with the fixing belt 102 therebetween. The contact member 152 is formed in an arc-like shape so as to contact the inner peripheral surface of the fixing belt 102.

The contact member 152 is in contact with a portion of the inner peripheral surface of the fixing belt 102 which opposes the excitation coil 110 along the peripheral direction of the fixing belt 102.

### [Contact Member]

The contact member 152 includes a temperature-sensitive magnetic plate 114 and a substrate 154. The temperature-sensitive magnetic plate 114 is molded with a temperature-sensitive magnetic member, and the substrate 154 is disposed on the side of the temperature-sensitive magnetic plate 114 which does not face the fixing belt 102.

A support member 118 for supporting the contact member 152 is disposed farther inward than the contact member 152 (on the left side of the contact member 152 in FIG. 2). A temperature detection sensor 135 for detecting the temperature of the temperature-sensitive magnetic plate 114 is disposed farther inward than the fixing belt 102 and close to a region where a sheet member P enters (region on the lower side of FIG. 2).

Details of the contact member 152 will be discussed later.

### [Support Member]

The support member 118 extends in the depth direction of the fixing device 80 and is formed by folding an aluminum plate. The support member 118 is disposed such that it stretches between the upper portion and the lower portion of the contact member 152. The upper portion of the support member 118 supports the upper portion of the contact member 152, while the lower portion of the support member 118 supports the lower portion of the contact member 152.

The support member 118 has a thickness equal to or greater than the above-described skin depth so as to prevent the magnetic flux of the magnetic field H from penetrating through the support member 118.

### [Frame]

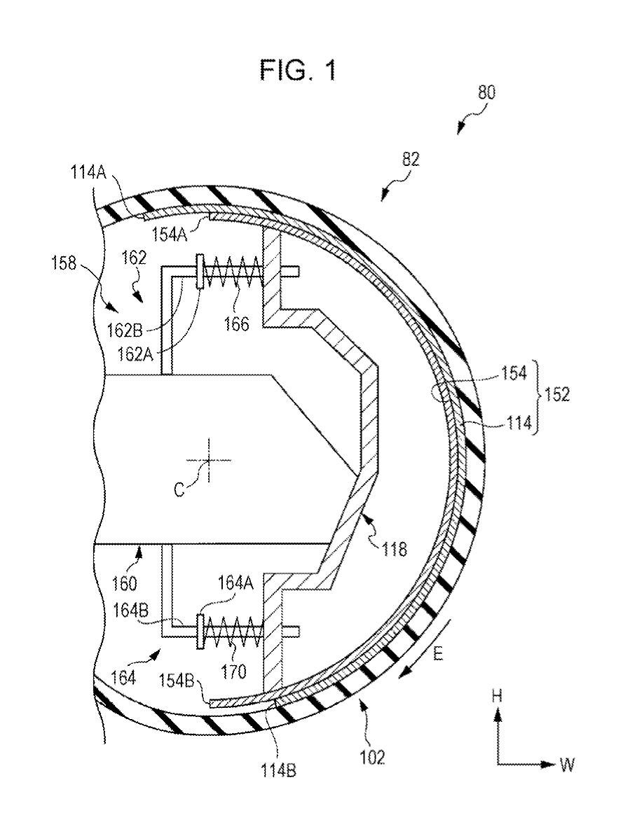

As shown in FIG. 1, a frame 158 is disposed on the side opposite the contact member 152 with the support member 118 therebetween. The frame 158 includes a body member 160 and upper and lower support members 162 and 164. The body member 160 extends in the depth direction of the fixing device 80. The upper support member 162 supports the upper portion of the support member 118, while the lower support member 164 supports the lower portion of the support member 118.

The body member 160 has a pentagon shape, as viewed from the depth direction of the fixing device 80 (see FIG. 2), and extends in the depth direction. Both ends of the body member 160 in the depth direction are fixed to the housing 120 (see FIG. 2). The body member 160 contacts and supports the support member 118.

The upper support member 162 is fixed on the top surface of the body member 160, while the lower support member 164 is fixed on the bottom surface of the body member 160.

The upper support member 162 is formed in an L shape by folding a cylindrical rod. Plural upper support members 162 are located in the depth direction of the fixing device 80 separately from each other. In the upper support member 162, an enlarged portion 162A is formed on an extending portion 162B which extends in the widthwise direction of the fixing device 80 toward the support member 118. The leading end of the extending portion 162B passes through a through-hole (not shown) formed in the support member 118. With this configuration, the upper portion of the support member 118 is guided by the extending portion 162B so as to be movable in the widthwise direction of the fixing device 80.

A coil spring 166 is provided between the enlarged portion 162A and the support member 118. The coil spring 166 urges the upper portion of the contact member 152 toward the inner peripheral surface of the fixing belt 102 via the support member 118.

The lower support member 164 is formed in an L shape by folding a cylindrical rod. Plural lower support members 164 are located in the depth direction of the fixing device 80 separately from each other. In the lower support member 164, an enlarged portion 164A is formed on an extending portion 164B which extends in the widthwise direction of the fixing device 80 toward the support member 118. The leading end of the extending portion 164B passes through a through-hole (not shown) formed in the support member 118. With this configuration, the lower portion of the support member 118 is guided by the extending portion 164B so as to be movable in the widthwise direction of the fixing device 80.

A coil spring 170 is provided between the enlarged portion 164A and the support member 118. The coil spring 170 urges the lower portion of the contact member 152 toward the inner peripheral surface of the fixing belt 102 via the support member 118.

As shown in FIG. 2, a pressing pad 132 for clamping the fixing belt 102 with the pressurizing roller 84 is fixed on the side of the body member 160 opposite the side contacting the support member 118. In this exemplary embodiment, as a material for the pressing pad 132, a liquid crystal polymer is used.

### [Pressurizing Roller]

As shown in FIG. 2, the pressurizing roller 84 includes a cored bar 84A made of a metal, such as aluminum, and a sponge elastic layer 84B covered with the cored bar 84A and made of foamed silicone rubber having a thickness of 5 mm. The pressurizing roller 84 also includes, on the exterior side of the sponge elastic layer 84B, a releasing layer (not shown) made of carbon-containing tetrafluoroethylene-perfluoroalkoxyethylene copolymer resin (PFA) having a thickness of 50 μm.

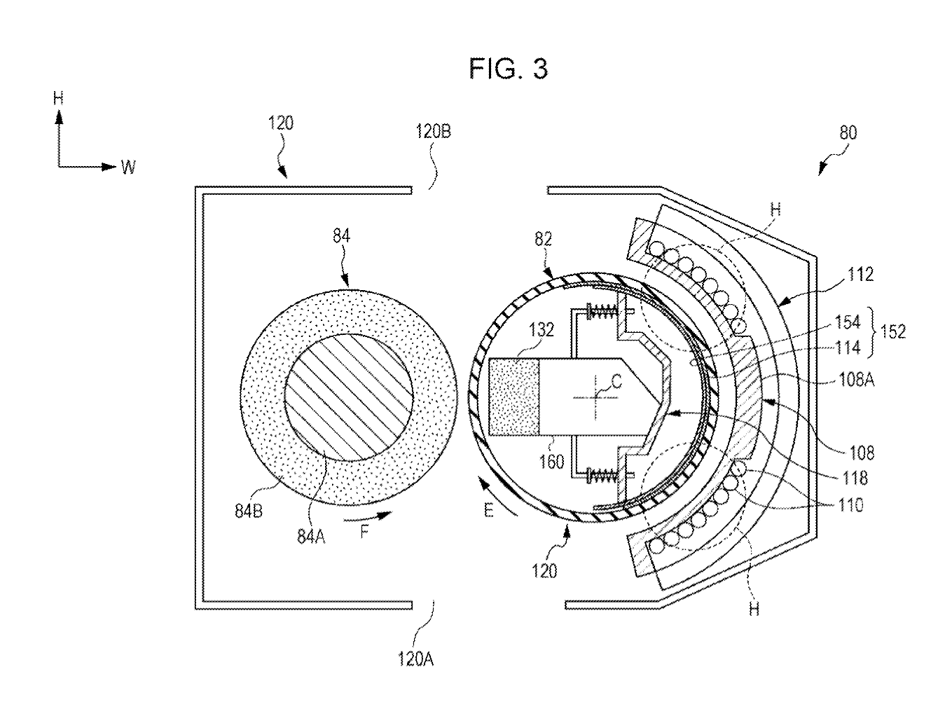

The cored bar 84A of the pressurizing roller 84 is movable by a retract mechanism (not shown) in the widthwise direction of the fixing device 80. B/y this retract mechanism, the pressurizing roller 84 is movable between a pressurizing position (see FIG. 2) at which the pressurizing roller 84 contacts and pressurizes the fixing belt 102 and a non-pressurizing position (see FIG. 3) at which the pressurizing roller 84 is separated from the fixing belt 102.

Torque is transferred from a motor (not shown) to the cored bar 84A of the pressurizing roller 84, so that the pressurizing roller 84 is rotated in the direction indicated by the arrow F (opposite the direction indicated by the arrow E) shown in FIG. 2.

### (Operation of Fixing Device)

When the fixing device 80 is not operating, the pressurizing roller 84 is located at the non-pressurizing position at which it is separated from the fixing belt 102, as shown in FIG. 3.

When a job instruction is given by a user and the image forming apparatus 10 starts to operate, a sheet member P having toner images transferred thereon is transported to the fixing device 80. Then, in the fixing device 80, the fixing belt 102 is subjected to torque from a motor (not shown) and starts to rotate in the direction indicated by the arrow E.

Then, an alternating current is supplied to the excitation coil 110, so that a magnetic field H, which is a magnetic circuit, repeatedly appears and disappears around the excitation coil 110. When the magnetic field H crosses the heat generating layer 126 (see FIG. 7) of the fixing belt 102, an eddy current is induced in the heat generating layer 126 so as to create a magnetic field which interrupts a change in the magnetic field H. Then, the fixing belt 102 generates heat.

After the fixing belt 102 has reached a preset fixing temperature, the pressurizing roller 84 is subjected to torque from a motor (not shown) and starts to rotate in the direction indicated by the arrow F. Then, the retract mechanism starts so that the pressurizing roller 84 shifts from the non-pressurizing position to the pressurizing position, as shown in FIG. 2. When the pressurizing roller 84 has shifted to the pressurizing position, the torque which is being transferred to the fixing belt 102 is canceled, and the fixing belt 102 starts to rotate in accordance with the rotation of the pressurizing roller 84.

Then, the sheet member P transported toward the fixing device 80 is heated and pressurized by the fixing belt 102 and the pressurizing roller 84 so that the toner images are fixed on the sheet member P.

After all jobs have been completed, the pressurizing roller 84 shifts from the pressurizing position to the non-pressurizing position and stops rotating. The supply of an alternating current to the excitation coil 110 is also stopped.

### (Configuration of Contact Member)

The contact member 152 will be discussed below.

As shown in FIG. 2, the contact member 152 includes a temperature-sensitive magnetic plate 114 molded with a temperature-sensitive magnetic member and a substrate 154 disposed on the side of the temperature-sensitive magnetic plate 114 which does not face the fixing belt 102, as discussed above.

The temperature-sensitive magnetic plate 114 is formed in an arc-like shape as viewed from the depth direction of the fixing device 80, and contacts a portion of the inner peripheral surface of the fixing belt 102 which opposes the excitation coil 110 in the radial direction. More specifically, the entirety of the temperature-sensitive magnetic plate 114 (from one end to the other end thereof in the rotating direction of the fixing belt 102) contacts the inner peripheral surface of the fixing belt 102.

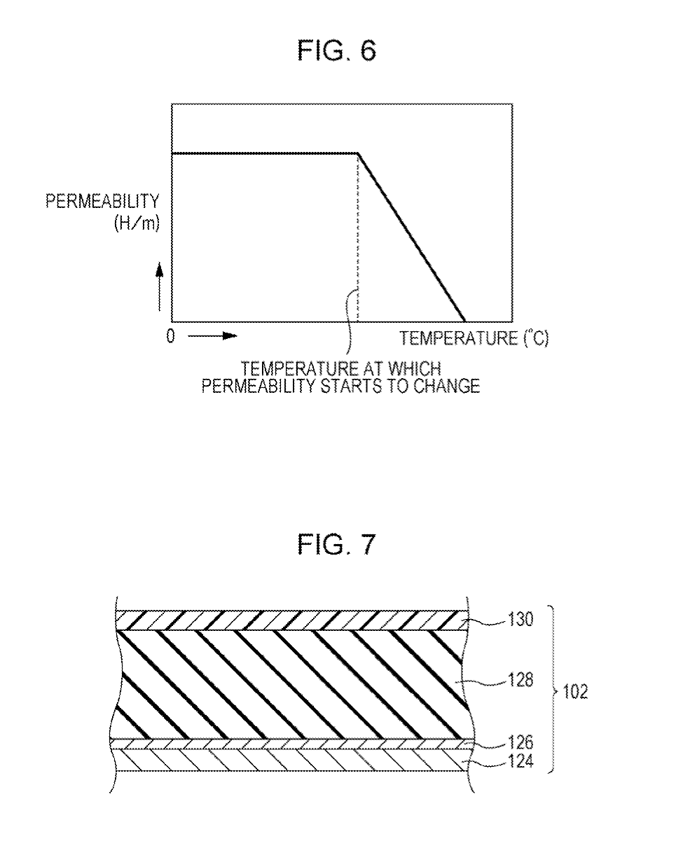

The temperature-sensitive magnetic plate 114 has temperature sensitive characteristics shown in FIG. 6. The temperature-sensitive magnetic plate 114 is constituted by a member having the following temperature sensitive characteristics. The permeability starts to change at a certain temperature in a temperature range which is equal to or higher than the preset fixing (heating) temperature of the fixing belt 102 and which is equal to or lower than the heat resistance temperature of the fixing belt 102. In this case, the permeability starts to continuously decrease at this certain temperature. With such characteristics, when the permeability of the temperature-sensitive magnetic plate 114 starts to decrease at this certain temperature due to an increase in the temperature of the temperature-sensitive magnetic plate 114, the amount of magnetic flux penetrating through the fixing belt 102 is reduced, thereby suppressing the generation of heat in the fixing belt 102. In this exemplary embodiment, as the temperature-sensitive magnetic plate 114, an iron-nickel (Fe—Ni) alloy having a thickness of 300 μm is used.

The temperature at which the permeability starts to change is a temperature at which the permeability (measured with JIS C2531) starts to decrease, and more specifically, a temperature at which the penetration amount of magnetic flux of a magnetic field starts to change.

As shown in FIG. 1, the substrate 154 is formed in an arc-like shape, as viewed from the depth direction of the fixing device 80, and is disposed on and contacts the side of the temperature-sensitive magnetic plate 114 which does not face the fixing belt 102. The substrate 154 and the temperature-sensitive magnetic plate 114 are fixed to each other by means of a fixing medium (not shown), for example, welding.

The substrate 154 is a member that conducts the heat generated in the temperature-sensitive magnetic plate 114 in the depth direction of the fixing device 80. By the provision of the substrate 154, the temperature distribution of the temperature-sensitive magnetic plate 114 in the depth direction of the fixing device 80 becomes uniform so that a local (partial) temperature rise can be suppressed. In this exemplary embodiment, as the substrate 154, aluminum having a thickness of 400 μm is used.

An upstream end 114A of the temperature-sensitive magnetic plate 114 and an upstream end 154A of the substrate 154 in the rotating direction of the fixing belt 102 are located upward with respect to the rotational axis C (center of the rotation) of the fixing belt 102.

In the rotating direction of the fixing belt 102, the upstream end 154A of the substrate 154 is located on the farther downstream side than the upstream end 114A of the temperature-sensitive magnetic plate 114. In this case, by considering the diameter of a droplet of a lubricant Oi, the upstream end 154A of the substrate 154 is preferably displaced from the upstream end 114A of the temperature-sensitive magnetic plate 114 by 1 mm or greater toward the farther downstream side in the rotating direction of the fixing belt 102. This will be discussed in detail later.

A downstream end 114B of the temperature-sensitive magnetic plate 114 and a downstream end 154B of the substrate 154 in the rotating direction of the fixing belt 102 are located downward with respect to the rotational axis C (center of the rotation) of the fixing belt 102.

In the rotating direction of the fixing belt 102, the downstream end 154B of the substrate 154 is located on the farther downstream side than the downstream end 114B of the temperature-sensitive magnetic plate 114.

### (Operation of Heating Unit)

The operation of the heating unit 82 will be described below in comparison with a heating unit 200 of a comparative example.

First, the configuration of the heating unit 200 of a comparative example will be described by referring to elements different from those of the heating unit 82 of the exemplary embodiment.

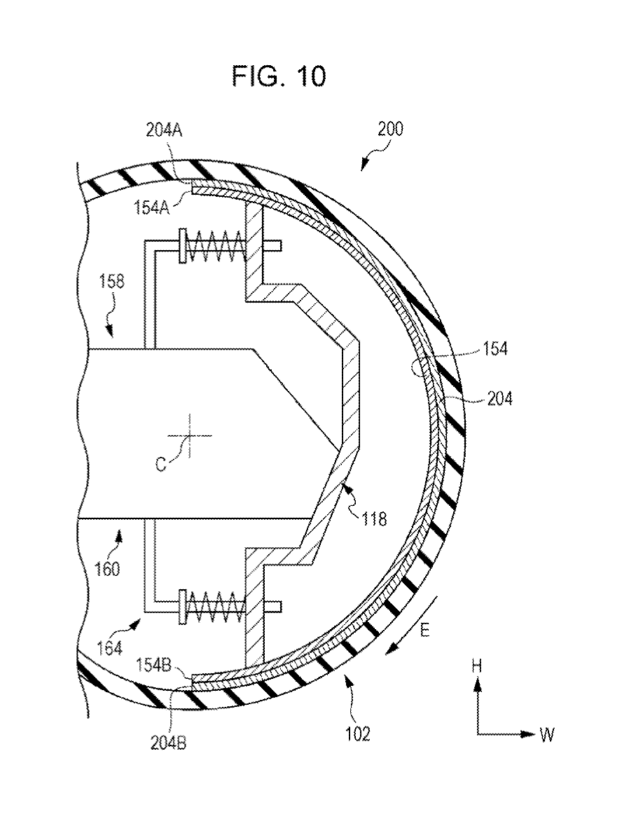

As shown in FIG. 10, an upstream end 204A of a temperature-sensitive magnetic plate 204 and an upstream end 154A of a substrate 154 in the rotating direction of the fixing belt 102 are located at similar positions.

Similarly, a downstream end 204B of the temperature-sensitive magnetic plate 204 and a downstream end 154B of the substrate 154 in the rotating direction of the fixing belt 102 are located at similar positions.

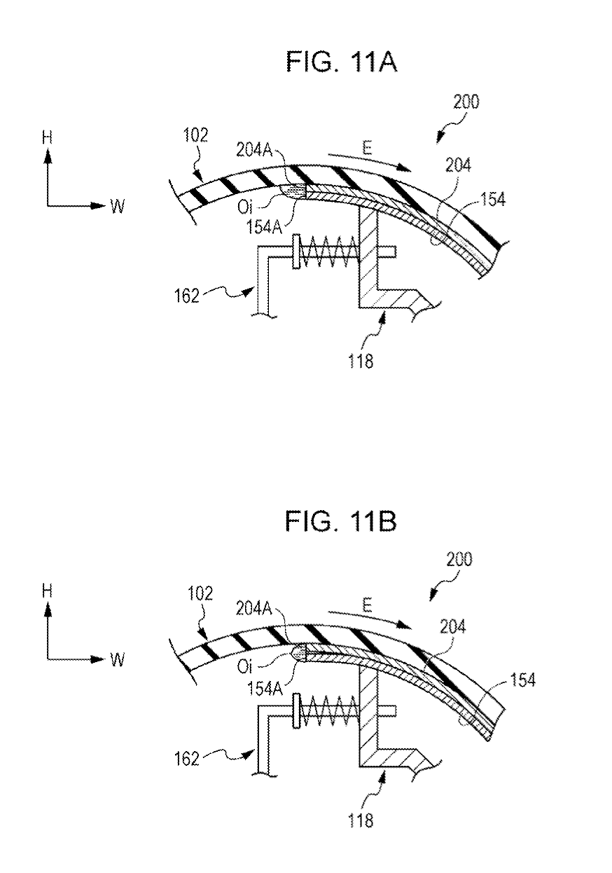

With this configuration, in the heating unit 200, when the fixing belt 102 starts to rotate in the direction indicated by the arrow E, part of a lubricant Oi applied to the inner peripheral surface of the fixing belt 102 is interrupted by the upstream ends 204A and 154A, as shown in FIG. 11A. Then, as shown in FIG. 11B, due to the capillary action, the interrupted lubricant Oi is sucked into a portion between the temperature-sensitive magnetic plate 204 and the substrate 154 through a gap between the upstream ends 204A and 154A. As a result, the amount of lubricant Oi applied to the inner peripheral surface of the fixing belt 102 is decreased.

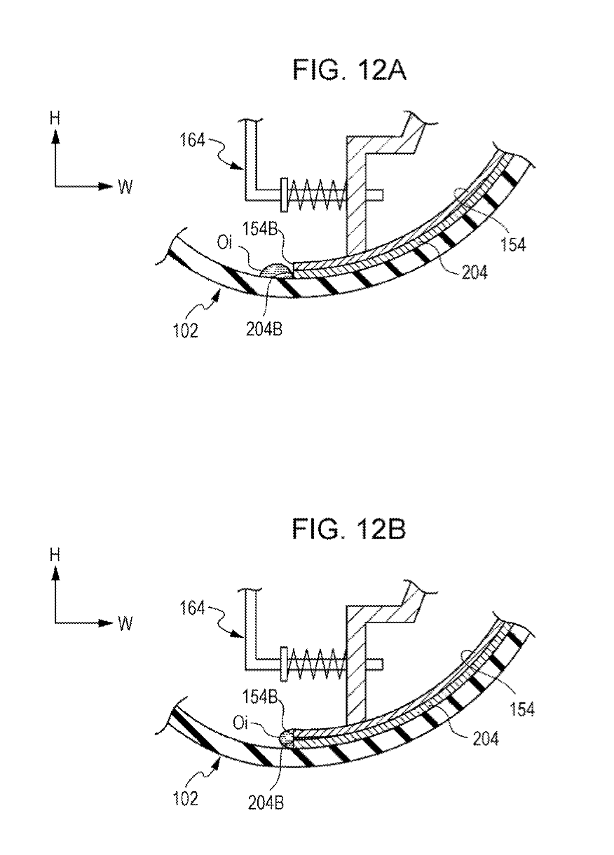

When the fixing belt 102 stops rotating, the lubricant Oi applied to the inner peripheral surface of the fixing belt 102 flows toward the downstream side and remains there. Then, as shown in FIGS. 12A and 12B, due to the capillary action, part of the lubricant Oi is sucked into a portion between the temperature-sensitive magnetic plate 204 and the substrate 154 through a gap between the downstream ends 204B and 154B. As a result, the amount of lubricant Oi applied to the inner peripheral surface of the fixing belt 102 is decreased.

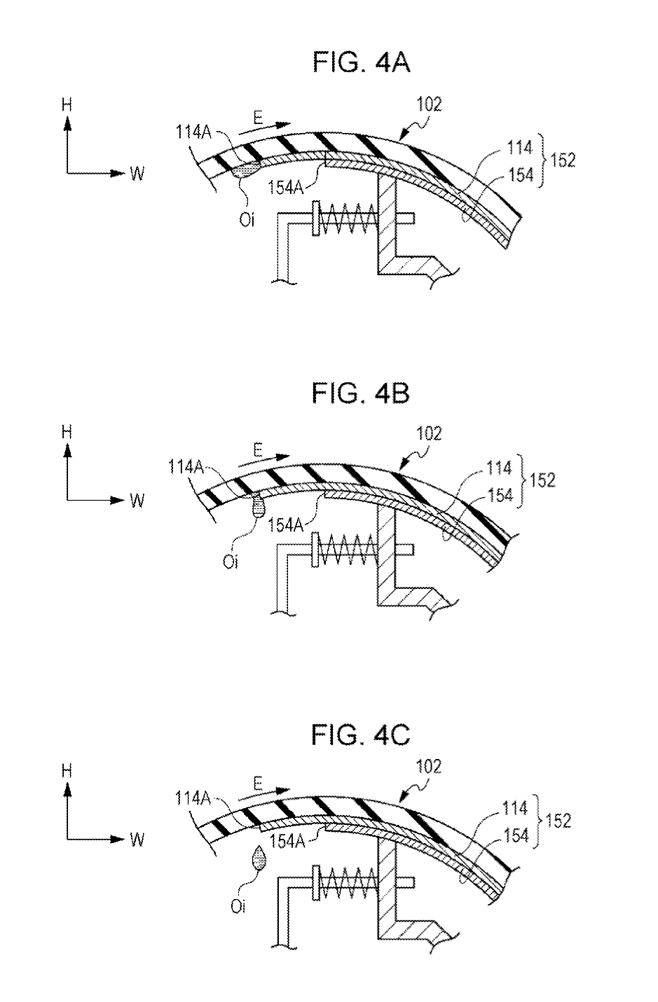

In contrast, in the heating unit 82 of this exemplary embodiment, when the fixing belt 102 starts to rotate in the direction indicated by the arrow E, part of a lubricant Oi applied to the inner peripheral surface of the fixing belt 102 is interrupted by the upstream end 114A, as shown in FIG. 4A. Since the upstream end 154A of the substrate 154 is positioned on the farther downstream side than the upstream end 114A of the temperature-sensitive magnetic plate 114 in the rotating direction of the fixing belt 102, the interrupted lubricant Oi stays at the upstream end 114A separately from the upstream end 154A.

Then, as shown in FIGS. 4B and 4C, the interrupted lubricant Oi drops from the upstream end 114A as a droplet. Accordingly, it is less likely that the lubricant Oi will be sucked into a portion between the temperature-sensitive magnetic plate 114 and the substrate 154 caused by the capillary action. Therefore, in the heating unit 82, it is less likely that the amount of lubricant Oi applied to the inner peripheral surface of the fixing belt 102 will be decreased.

The diameter of a droplet of the lubricant Oi at a fixing temperature (for example, 130 to 170° C.) is about 1 mm. By considering the diameter of a droplet of the lubricant Oi, the upstream end 154A of the substrate 154 is displaced from the upstream end 114A of the temperature-sensitive magnetic plate 114 by 1 mm or greater toward the downstream side of the rotating direction of the fixing belt 102. Then, a droplet of the lubricant Oi drops effectively.

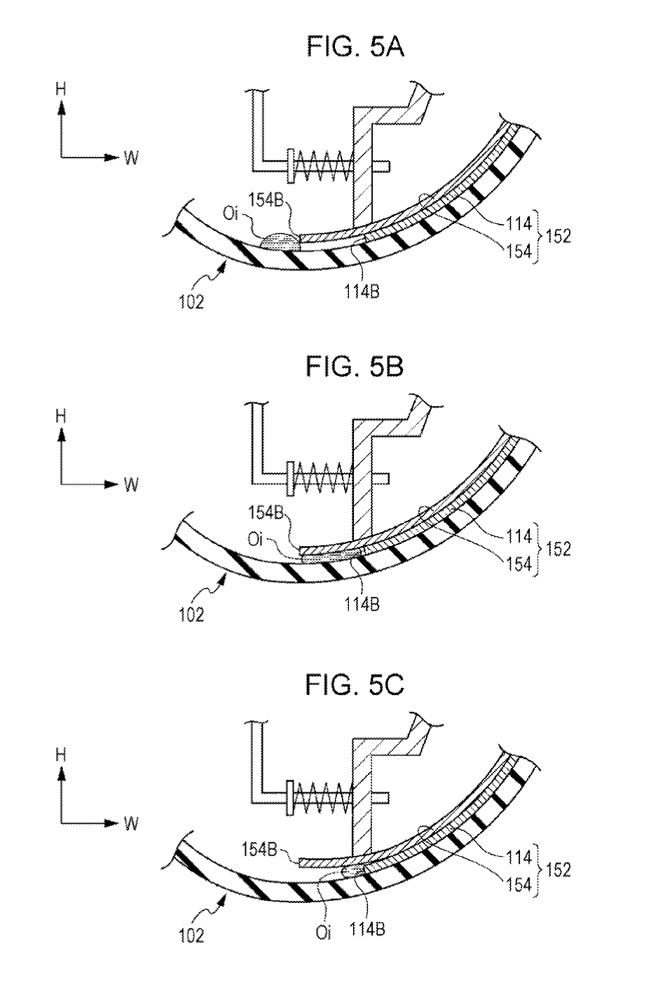

When the fixing belt 102 stops rotating, the lubricant Oi applied to the inner peripheral surface of the fixing belt 102 flows toward the downstream side of the fixing belt 102 and remains there. Then, as shown in FIGS. 5A and 5B, part of the lubricant Oi enters a portion between the substrate 154 and the fixing belt 102 through the downstream end 154B. Then, the lubricant Oi advances toward the downstream end 114B and is sucked into a portion between the temperature-sensitive magnetic plate 114 and the substrate 154 through the downstream end 114B due to the capillary action, as shown in FIG. 5C. In this manner, in the heating unit 82, after having moved between the substrate 154 and the fixing belt 102, the lubricant Oi is sucked into a portion between the temperature-sensitive magnetic plate 114 and the substrate 154 through the downstream end 114B due to the capillary action. Thus, it takes more time for the lubricant Oi to be sucked into a portion between the temperature-sensitive magnetic plate 114 and the substrate 154 than in the heating unit 200.

### [Evaluations]

Evaluations are conducted for the heating unit 82 of this exemplary embodiment and the heating unit 200 of the comparative example.

### [Evaluation Specifications]

As the heating unit 200 of the comparative example, the heating unit of Docu Centre 5575 made by Fuji Xerox Co., Ltd. is used. The ends of the temperature-sensitive magnetic plate 204 and the ends of the substrate 154 are not displaced from each other.

As the heating unit 82 of this exemplary embodiment, the heating unit of Docu Centre 5575 made by Fuji Xerox Co., Ltd. in which the ends of the temperature-sensitive magnetic plate 114 and the ends of the substrate 154 are displaced from each other is used. More specifically, the ends of the temperature-sensitive magnetic plate 114 and the ends of the substrate 154 are displaced from each other by about 3.9 mm.

### [Evaluation Method]

The mass of the contact member 152 of the heating unit 82 of this exemplary embodiment and that of the heating unit 200 of the comparative example are measured. Then, 0.5 ml of lubricant Oi is applied to the inner peripheral surface of the fixing belt 102 of the heating unit 82 and to that of the fixing belt 102 of the heating unit 200. Then, the fixing belts 102 of the heating units 82 and 200 are rotated for ten minutes in a state in which heat is not applied.

After the fixing belts 102 stop rotating, the mass of the contact member 152 of the heating unit 82 and that of the heating unit 200 are measured.

In this manner, by measuring the masses of the contact member 152 of the heating unit 82 and those of the heating unit 200 before and after rotating the fixing belts 102, the amount of lubricant Oi sucked into a portion between each of the temperature-sensitive magnetic plates 114 and 204 and the substrate 154 through the upstream end of the contact member due to the capillary action is determined by considering the density of the lubricant Oi.

### [Evaluation Results]

In the heating unit 200 of the comparative example, 0.3 ml of lubricant Oi is sucked into a portion between the temperature-sensitive magnetic plate 204 and the substrate 154. In other words, the lubricant Oi applied to the inner peripheral surface of the fixing belt 102 is decreased by 0.3 ml.

In contrast, in the heating unit 82 of this exemplary embodiment, 0.05 ml of lubricant Oi is sucked into a portion between the temperature-sensitive magnetic plate 114 and the substrate 154. In other words, the lubricant Oi applied to the inner peripheral surface of the fixing belt 102 is decreased by 0.05 ml.

The present invention is not restricted to the above-described exemplary embodiment, and it is apparent for those skilled in the art that various other embodiments may be employed within the spirit of the invention. For example, in the above-described exemplary embodiment, the downstream end 154B of the substrate 154 is displaced from the downstream end 114B of the temperature-sensitive magnetic plate 114 in the rotating direction of the fixing belt 102. However, the downstream ends 154B and 114B may not be displaced from each other.

In the above-described exemplary embodiment, the upstream end 114A of the temperature-sensitive magnetic plate 114 and the upstream end 154A of the substrate 154 are located upward with respect to the rotational axis C of the fixing belt 102, but they may be located at another position. The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A heating unit comprising:
a magnetic-field generating member that generates a magnetic field;
an endless belt-shaped member that is formed in an endless belt shape and has an inner peripheral surface to which a lubricant is applied and an outer peripheral surface, a portion of the outer peripheral surface opposing the magnetic-field generating member, and that rotates in a peripheral direction and generates heat by electromagnetic induction of the magnetic field;
a temperature-sensitive magnetic plate that is in contact with a portion of the inner peripheral surface of the endless belt-shaped member which opposes the magnetic-field generating member; and
a substrate that is disposed on a side of the temperature-sensitive magnetic plate which does not face the endless belt-shaped member, an upstream end of the substrate being positioned farther downstream than an upstream end of the temperature-sensitive magnetic plate in a rotating direction of the endless belt-shaped member,
wherein the temperature-sensitive magnetic plate contacts the endless belt-shaped member along an entire length of the temperature-sensitive magnetic plate.

2. The heating unit according to claim 1, wherein:
in the rotating direction of the endless belt-shaped member, a downstream end of the temperature-sensitive magnetic plate and a downstream end of the substrate are located downward with respect to a center of rotation of the endless belt-shaped member; and
the downstream end of the substrate is positioned on a farther downstream side than the downstream end of the temperature-sensitive magnetic plate in the rotating direction of the endless belt-shaped member.

3. A fixing device comprising:
a heating unit; and
a pressurizing member that pressurizes a recording medium in a direction toward the heating unit,
the heating unit including,
a magnetic-field generating member that generates a magnetic field,
an endless belt-shaped member that is formed in an endless belt shape and has an inner peripheral surface to which a lubricant is applied and an outer peripheral surface, a portion of the outer peripheral surface opposing the magnetic-field generating member, and that rotates in a peripheral direction and generates heat by electromagnetic induction of the magnetic field,
a temperature-sensitive magnetic plate that is in contact with a portion of the inner peripheral surface of the endless belt-shaped member which opposes the magnetic-field generating member, and
a substrate that is disposed on a side of the temperature-sensitive magnetic plate which does not face the endless belt-shaped member, an upstream end of the substrate being positioned farther downstream than an upstream end of the temperature-sensitive magnetic plate in a rotating direction of the endless belt-shaped member,
wherein the temperature-sensitive magnetic plate contacts the endless belt-shaped member along an entire length of the temperature-sensitive magnetic plate.

4. An image forming apparatus comprising:
an image forming device that forms an image on a recording medium; and
a fixing device that fixes the image onto the recording medium,
the fixing device including
a heating unit, and
a pressurizing member that pressurizes a recording medium in a direction toward the heating unit,
the heating unit including,
a magnetic-field generating member that generates a magnetic field,
an endless belt-shaped member that is formed in an endless belt shape and has an inner peripheral surface to which a lubricant is applied and an outer peripheral surface, a portion of the outer peripheral surface opposing the magnetic-field generating member, and that rotates in a peripheral direction and generates heat by electromagnetic induction of the magnetic field,
a temperature-sensitive magnetic plate that is in contact with a portion of the inner peripheral surface of the endless belt-shaped member which opposes the magnetic-field generating member, and
a substrate that is disposed on a side of the temperature-sensitive magnetic plate which does not face the endless belt-shaped member, an upstream end of the substrate being positioned farther downstream than an upstream end of the temperature-sensitive magnetic plate in a rotating direction of the endless belt-shaped member,
wherein the temperature-sensitive magnetic plate contacts the endless belt-shaped member along an entire length of the temperature-sensitive magnetic plate.
